(19) United States
(12) Patent Application Publication
(10) Pub. No.: US 2026/0045753 A1
(43) Pub. Date: Feb. 12, 2026

(54) Method for Readjusting a Laser System

(71) Applicant: Robert Bosch GmbH, Stuttgart (DE)

(72) Inventors: Joern Hoffarth, Reutlingen (DE); David Copeto, Ludwigsburg (DE); Stefan Noe, Stuttgart (DE)

(21) Appl. No.: 19/289,052

(22) Filed: Aug. 3, 2025

(30) Foreign Application Priority Data
Aug. 7, 2024 (DE) 10 2024 207 477.2

(51) Int. Cl. H01S 3/00; G01C 3/02; H01S 3/13

(52) U.S. Cl. CPC H01S 3/0057; G01C 3/02; H01S 3/0085; H01S 3/1305

(57) ABSTRACT

A method for readjusting a laser system includes (i) specifying a time window in which a change in a modulation frequency of the laser system is carried out, (ii) blocking a measurement by the laser system in the specified time window, and (iii) performing the readjustment of the laser system in the specified time window, wherein a digital-analog converter of the laser system is set to provide precise control of analog signals of the laser system. A computer program, an apparatus, and a storage medium for this purpose is also disclosed.

This application claims priority under 35 U.S.C. § 119 to application no. DE 10 2024 207 477.2, filed on Aug. 7, 2024 in Germany, the disclosure of which is incorporated herein by reference in its entirety.

The disclosure relates to a method for readjusting a laser system. The disclosure further relates to a computer program, an apparatus, and a storage medium for this purpose.

### BACKGROUND

Readjusting a laser system during a measurement process can lead to signal interference, especially with very short measurement times. This signal interference can occur synchronized, especially if a measuring machine of the laser system and the laser control share the same system clock. Such an interference can affect the measuring accuracy of the laser system.

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the apparatus according to the disclosure, and the computer-readable storage medium according to the disclosure, and vice versa in each case, so that a reciprocal reference is always possible with regard to the disclosure of the disclosure.

The subject matter of the disclosure is in particular a method for readjusting, in particular selectively readjusting, a laser system, comprising the following steps, wherein the steps can be carried out repeatedly and/or successively. For example, the laser system may be a laser rangefinder. Targeted readjustment can refer to the fact that readjustment is carried out at specific instant.

In a first step, a time window is preferably specified in which a change of a modulation frequency of the laser system is carried out. The modulation frequency refers in particular to a modulated emitted light of a laser of the laser system.

In a further step, a measurement is blocked by the laser system in the specified time window. The measurement by the laser system relates in particular to a measurement of reflected light in the context of a range measurement, if the laser system is designed as a laser rangefinder. Blocking the measurement can indicate that no sensor data is being recorded during the specified time window, or that recorded sensor data is not being processed or taken into account.

In a further step, the laser system is preferably readjusted within the specified time window. The readjustment can be carried out, for example, by a measuring controller of the laser system. A signal from a measurement state machine preferably specifies the time window in which the modulation frequencies are to be changed to the measurement controller of the laser rangefinder. For example, a digital-analog converter of the laser system can be set or adjusted to provide precise control of analog signals of the laser system. Sensors can continuously monitor parameters such as a laser output, i.e. an output power of a laser of the laser system, a laser current, temperatures in the laser system or other control-relevant variables. This information can be fed back to the measuring controller. Based on this feedback, the measuring controller can adjust the digital control signals that are sent to the digital-analog converter.

The method according to the disclosure can advantageously prevent or at least reduce interference in the measurement by the laser system, which is caused by readjustment during the measurement.

Furthermore, within the scope of the disclosure, it is optionally possible for the time window to be specified for regular defined intervals in order to carry out the readjustment at the regular defined intervals. For example, a respective time window could be provided every 15 ms, which has a length of 10 μs, for example.

Preferably, it can be provided that the regular defined intervals are specified synchronized with a change in the modulation frequency of the laser system during a measurement process. In other words, the time window can be specified for the change between two modulation frequencies in order to carry out the readjustment in each case. This ensures that readjustment is only ever carried out when the modulation frequency changes.

It may be advantageous if the disclosure provides that the method further comprises the following step:
simulating the change of the modulation frequency outside the measurement process in order to provide an identical control frequency of the readjustment inside and outside the measurement process.

This allows the same configuration set of the measurement controller, i.e. for example the same filter bandwidth and/or the same amplification factor, to be used outside the measurement process as during the measurement process.

For example, it may be provided that the method also comprises the following steps before specifying the time window:
defining a target value for the laser output of the laser system,
determining the current laser output of the laser system,
comparing the current laser output with the defined target value,
performing readjustment of the laser system if the current laser output exceeds or falls below the defined target value by a defined amount.

The target value can be defined in order to bridge a hysteresis of the laser system and only carry out the presetting of the time window once the target value has been reached, or once an interval within the defined quantity has been reached. The defined quantity can also be 1 or zero, so it is also conceivable that the defined target value itself must be exceeded or reached. The current laser output can be determined using a suitable sensor in the laser system.

A further advantage in the context of the disclosure can be achieved if the method further comprises the following step:
determining a new current laser output after performing the readjustment of the laser system,
comparing the new current laser output with the defined target value,
initiating a safe state of the laser system when the new current laser output exceeds or falls below the defined target value by a defined amount, wherein in the safe state a reduced amount of light, in particular no light, is emitted by the laser system.

In particular, it is determined whether rule-free measurement is possible. This makes it possible to determine whether the readjustment was successful and whether the defined target value has now been reached. If this is not the case, it may be advantageous to transfer the laser system to the safe state in order to avoid possible faults, damage or hazards. It may also be possible to readjust and compare several times, for example for a certain number or duration, before the safe state is initiated. A manual or automated error analysis can then be carried out. The reduced amount of light is particularly harmless to human eyes.

Another object of the disclosure is a computer program, in particular a computer program product, comprising commands which, when the computer program is executed by a computer, cause the computer to carry out the method according to the disclosure. The computer program according to the disclosure thus brings with it the same advantages as have been described in detail with reference to a method according to the disclosure.

The disclosure also relates to an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution. The device may also be an analog discrete electronic circuit or an integrated electronic circuit that is appropriately configured to perform the method according to the disclosure.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a device, a storage medium, and a computer program according to exemplary embodiments of the disclosure,

FIG. 2 a schematic illustration of a laser system according to exemplary embodiments of the disclosure.

### DETAILED DESCRIPTION

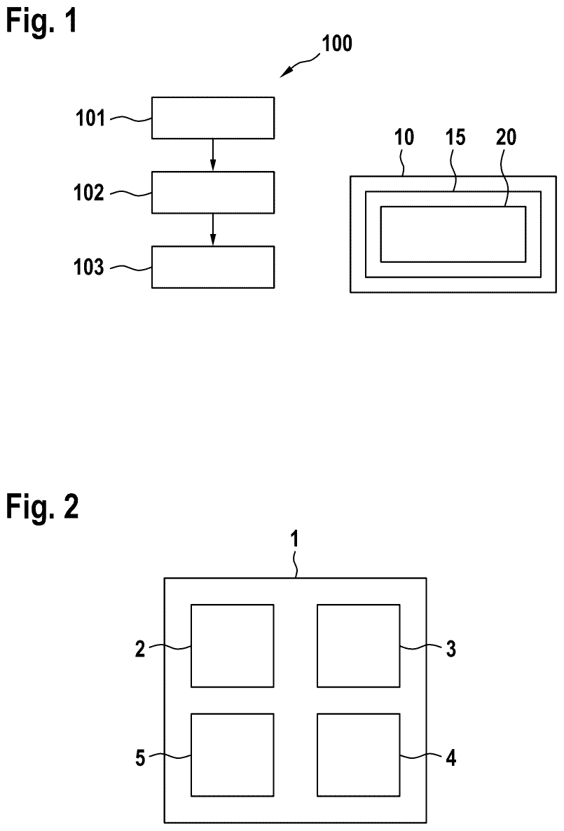

FIG. 1 schematically illustrates a method 100, a device 10, a storage medium 15, and a computer program 20 according to exemplary embodiments of the disclosure.

FIG. 1 shows in particular an exemplary embodiment of a method 100 for readjusting a laser system 1. In a first step 101, a time window is predetermined in which a change of a modulation frequency of the laser system 1 is carried out. In a second step 102, a measurement is blocked by the laser system 1 in the predetermined time window. In a third step 103, the readjustment of the laser system 1 is performed in the specified time window, wherein a digital-analog converter 5 of the laser system is provided to provide precise control of analog signals of the laser system.

The method of the present disclosure relates to a laser system 1 and, according to exemplary embodiments, in particular to a laser rangefinder that uses indirect time of flight (iToF) measurement. For this exemplary embodiment, reference is made to FIG. 2. This laser rangefinder 1 operates, for example, by measuring a phase shift of a modulated light signal that is emitted by the laser rangefinder and reflected by a target object. The functionality of the indirect time of flight (iToF) measurement is described below. First of all, a laser 3 in the laser rangefinder 1 can emit modulated light, for example in the infrared or visible range, in the direction of a target object. Modulation takes place in particular with a sinusoidal or square wave. The modulated light then hits the target object and is reflected back to the laser rangefinder 1. A detector 4 in the rangefinder can now receive the reflected light. As the light needs a certain amount of time to travel the distance there and back, there is a phase shift between the emitted and received signal. This phase shift between the transmitted and received signal can then be measured. This phase shift is particularly proportional to the distance traveled by the light. The distance can then be calculated from the phase shift, taking into account the wavelength of the modulation and the speed of light. It can also be provided that a reference phase is determined at a constant interval in order to determine the phase shift on the basis of a comparison with the reference phase.

Several modulation frequencies can be used to increase the measurement accuracy and range and to avoid ambiguities in the phase measurement. For example, two, three, four, eight or even 16 different modulation frequencies could be used. A measurement state machine, which can also be referred to as a measurement state machine, can be used to change the modulation frequencies. The measurement state machine is, in particular, a model that can be used to control and manage measurement processes. In particular, it is based on the concept of a state machine, which defines different states and transitions between these states. These states represent different phases or steps in the measurement process, for example initialization, measurement, measurement with a specific modulation frequency, data storage or error handling. Transitions can define how and when the change from one state to another takes place. These are triggered, for example, by events or conditions, such as the arrival of a measurement signal or reaching a time limit. Inputs are, for example, start signals, measured values or error conditions. Outputs can be actions or reactions of the measurement state machine to a specific state or transition. This includes, for example, sending signals, saving data or triggering alarms.

The laser rangefinder 1 can have a measuring controller 2. In particular, the measuring controller 2 controls the laser 3.

The measuring controller 2 can thus control an emission of the laser 3 by regulating the switching on and off as well as the intensity of a laser beam of the laser 3. This ensures that the laser beam is emitted with the correct power and properties.

Furthermore, a laser beam of the laser system 1 can be modulated, for example in the form of pulsed light and/or a continuous wave with a variable modulation frequency. After the reflected laser beam has been received by the detector 4, the received signal can be processed. This comprises, for example, amplification, filtering and conversion of the received analog signal into a digital signal for further analysis, in particular by an analog-to-digital converter (not shown). Furthermore, the phase shift between the transmitted and received signal can be measured and, if necessary, compared with the reference phase.

The measuring controller 2 can also perform regular calibrations to ensure that the measurements are accurate. To do this, it can monitor the status of laser 3 and detector 4 to ensure that they are working properly.

As part of the method according to exemplary embodiments of the disclosure, a signal from a measurement state machine preferably provides the measurement controller 2 of the laser rangefinder 1 with a time window in which the modulation frequencies are changed. In particular, measurements cannot be taken during the frequency change. The measuring controller 2 can use this time window to readjust. If a measurement is ended but the laser 3 continues to operate, a replacement timer in the measurement controller 2 preferably jumps in and simulates the timing of a measurement process. This means that a control frequency can be identical and the same configuration set (filter bandwidth, amplification factor) can be used as during the measurement. If the laser output deviates by a defined amount from a defined target value, the measuring controller 2 preferably starts immediately and attempts to take corrective action. If it fails to do so, the safety limits already described are preferably exceeded and the laser 3 goes into a safe state, whereby the safe state is in particular a safe state in which the laser system 1 does not emit any light.

In particular, it is therefore intended that an alternative clock is generated when the measuring state machine is switched off.

When laser 3 is started, the laser output is still too low and therefore outside the hysteresis. A digital-analog converter 5 can be continuously adjusted by a corresponding signal as part of the readjustment process. Once the defined target value of the laser output has been reached, a time window is preferably only enabled during the frequency change by readjusting the digital-analog converter 5.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for readjusting a laser system, comprising:
specifying a time window in which a change in a modulation frequency of the laser system is carried out;
blocking a measurement by the laser system in the specified time window; and
performing the readjustment of the laser system in the specified time window, wherein a digital-analog converter of the laser system is set to provide precise control of analog signals of the laser system.

2. The method according to claim 1, wherein the time window for regular defined intervals is specified in order to perform the readjustment at the regular defined intervals in each case.

3. The method according to claim 2, wherein the regular defined intervals are specified synchronously with a change in the modulation frequency of the laser system during a measurement process.

4. The method according to claim 3, further comprising simulating the change of the modulation frequency outside the measurement process in order to provide an identical control frequency of the readjustment inside and outside the measurement process.

5. The method according to claim 1, further comprising the following steps before specifying the time window:
defining a target value for the laser output of the laser system,
determining the current laser output of the laser system,
comparing the current laser output with the defined target value,
performing readjustment of the laser system if the current laser output exceeds or falls below the defined target value by a defined amount.

6. The method according to claim 5, further comprising:
determining a new current laser output after performing the readjustment of the laser system;
comparing the new current laser output with the defined target value; and
initiating a safe state of the laser system when the new current laser output exceeds or falls below the defined target value by a defined amount,
wherein, in the safe state, a reduced amount of light is emitted by the laser system.

7. The method according to claim 1, wherein:
the laser system is a laser rangefinder, and
the readjustment is carried out by a measuring controller of the laser rangefinder.

8. A computer program comprising instructions for causing the computer to carry out the method according to claim 1 when the computer program is executed by a computer.

9. A device for data processing, configured to carry out the method according to claim 1.

10. A computer-readable storage medium, comprising instructions which, when executed by a computer, cause it to carry out the steps of the method according to claim 1.

11. The method according to claim 6, wherein:
in the safe state, no light is emitted by the laser system.
